(19) United States
(12) Patent Application Publication
(10) Pub. No.: US 2005/0047161 A1
(43) Pub. Date: Mar. 3, 2005

(54) Centrifugal force-activated signal light assembly for vehicles

(76) Inventor: Mei-Hui Tai, Taipei City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/647,324

(22) Filed: Aug. 26, 2003

(51) Int. Cl. B60Q 1/00

(52) U.S. Cl. 362/500; 362/543; 362/464; 362/276; 362/394

(57) ABSTRACT

A centrifugal force-activated signal light assembly for use in a vehicle is disclosed in which a metal weight is suspended from a metal conical spring at the bottom side of a set of battery cells inside a metal casing and vibrated to touch the metal casing intermittently upon running of the vehicle wheel in which the assembly is installed, causing the LED to flash.

### BACKGROUND OF THE INVENTION

1. Field of the Invention

The present invention relates to lights for vehicles and, more particularly, to a centrifugal force-activated signal light assembly for installation in the wheels of a vehicle and adapted to emit light intermittently upon running of the vehicle.

2. Description of the Related Art

People may attach reflecting paper or lenses to their vehicle to give a warning signal in the dark. However, these reflecting paper or lenses wear quickly with use. Further, these reflecting paper or lenses do not give any warning signal actively when in the dark without the radiation of an external light source.

Therefore, it is desirable to provide a centrifugal force-activated signal light assembly for vehicles that eliminates the aforesaid problem.

### SUMMARY OF THE INVENTION

The present invention has been accomplished under the circumstances in view. According to one aspect of the present invention, a metal weight is suspended from a metal conical spring at the bottom side of a set of battery cells inside a metal casing and vibrated to touch the metal casing intermittently upon running of the vehicle wheel in which the assembly is installed, causing the LED to flash. According to another aspect of the present invention, a ring cushion is provided to space the respective lead wire of the LED from the corresponding terminal of the battery cells, keeping the circuit off when the vehicle is immovable. According to still another aspect of the present invention, the casing has a bottom screw hole for fastening to the air valve of a vehicle wheel. According to still another aspect of the present invention, a mounting plate is provided for fastening the casing to the spokes of a vehicle wheel.

### BRIEF DESCRIPTION OF THE DRAWINGS

FIG. 1 is an elevational view of a centrifugal force-activated signal light assembly according to the present invention.

FIG. 2 is an exploded view of the centrifugal force-activated signal light assembly according to the present invention.

FIG. 3 is a sectional assembly view of the centrifugal force-activated signal light assembly according to the present invention.

FIG. 4 is a schematic drawing of the present invention, showing the weight touched the inside wall of the casing, the LED turned on.

FIG. 5 is a sectional view of the present invention, showing the centrifugal force-activated signal light assembly immovable, the circuit opened.

FIG. 6 shows centrifugal force-activated signal light assemblies installed in a vehicle wheel according to the present invention.

FIG. 7 is an exploded view in section of the present invention, showing the relationship between a centrifugal force-activated signal light assembly and the air valve of a vehicle wheel.

FIG. 8 is an exploded view in an enlarged scale of a part of FIG. 6.

FIG. 9 is an exploded view of an alternate form of the centrifugal force-activated signal light assembly according to the present invention.

FIG. 10 is a sectional assembly view in an enlarged scale of FIG. 9.

### DETAILED DESCRIPTION OF THE PREFERRED EMBODIMENT

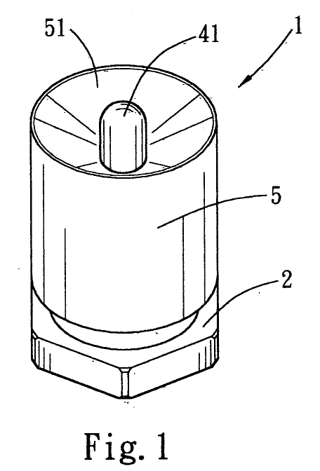

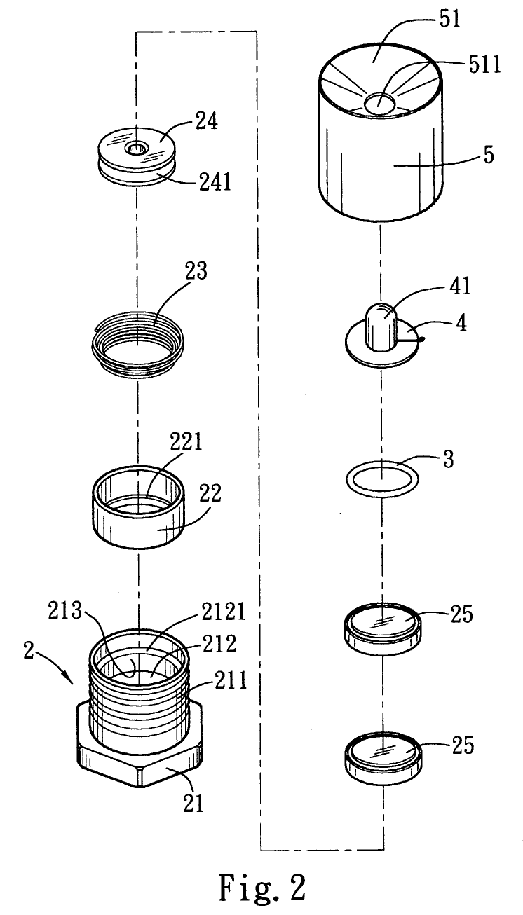

Referring to FIGS. 1˜5, a centrifugal force-activated signal light assembly 1 for vehicles in accordance with the present invention is shown comprised of a metal casing 2, an electrically insulative battery holder 22, a metal conical spring 23, a metal weight 24, a set of battery cells 25, a ring cushion 3, a circuit board 4 carrying a LED (or bulb) 41, and a metal cover 5.

The metal casing 2 comprises a base 21, a cylindrical chamber 212 perpendicularly upwardly extended from the base 21, an outer thread 211 extended around the periphery of the cylindrical chamber 212, a locating groove 2121 in the inside wall 213 of the cylindrical chamber 212, and a bottom screw hole 214 at the center of the bottom side of the base 21.

The battery holder 22 is shaped like a stub tube mounted in the locating groove 2121 inside the cylindrical chamber 212 of the casing 2, having an annular inside flange 221 suspended in the bottom open side.

The metal conical spring 23 is inserted through the bottom open side of the battery holder 22, having the top side of relatively greater diameter fastened to the annular inside flange 221 of the battery holder 22 and the bottom side of relatively smaller diameter spaced below the battery holder 22 at a distance.

The metal weight 24 is fastened to the metal conical spring 23 and suspended in the cylindrical chamber 212 below the battery holder 22 without touching the inside wall 213 of the cylindrical chamber 212, having an annular groove 241 extended around the periphery and fastened to the bottom side of the metal conical spring 23.

The battery cells 25 are mounted in the cylindrical chamber 212 of the casing 2 and supported on the metal conical spring 23, and connected in series with one terminal (for example, the negative terminal) disposed in contact with the metal conical spring 23.

The metal cover 5 is fastened to the casing 2 to close the cylindrical chamber 212, having an inner thread 53 threaded onto the outer thread 211 of the casing 2, a reflector 51 provided at the top side and curved inwards, and a center hole 511 through the center of the reflector 51.

The circuit board 4 is mounted inside the cover 5, keeping the LED 41 extended out of the center hole 511. The LED 41 has one lead wire (positive pole) adapted to contact the other terminal (positive terminal) of the battery cells 25 and the other lead wire (negative pole) connected to the inside wall of the metal cover 5.

The ring cushion 3 is mounted in between the battery cells 25 and the circuit board 4, keeping the positive pole lead wire of the LED 41 spaced above the positive terminal of the battery cells 25.

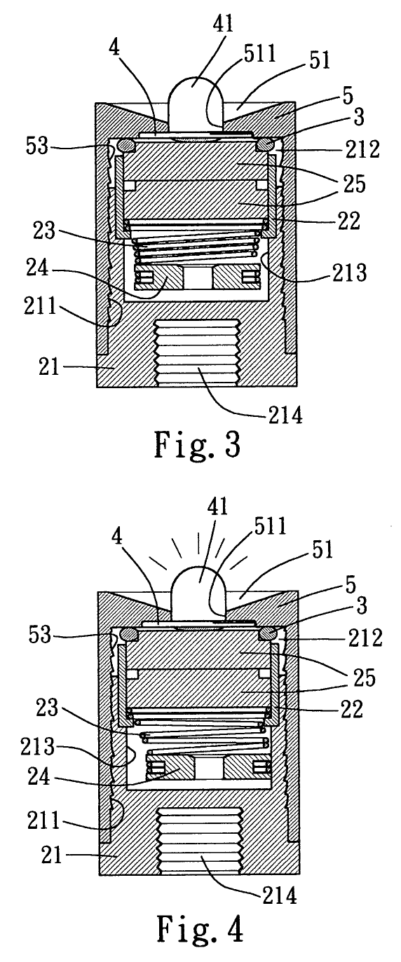

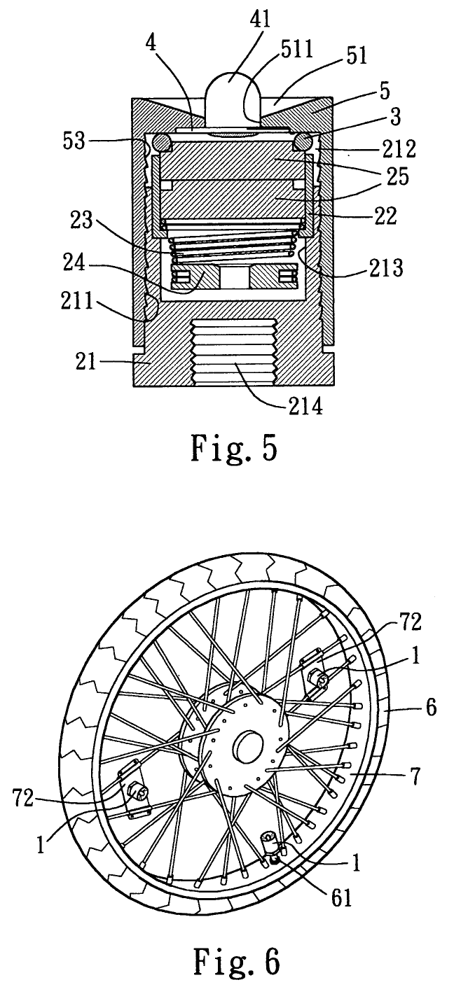

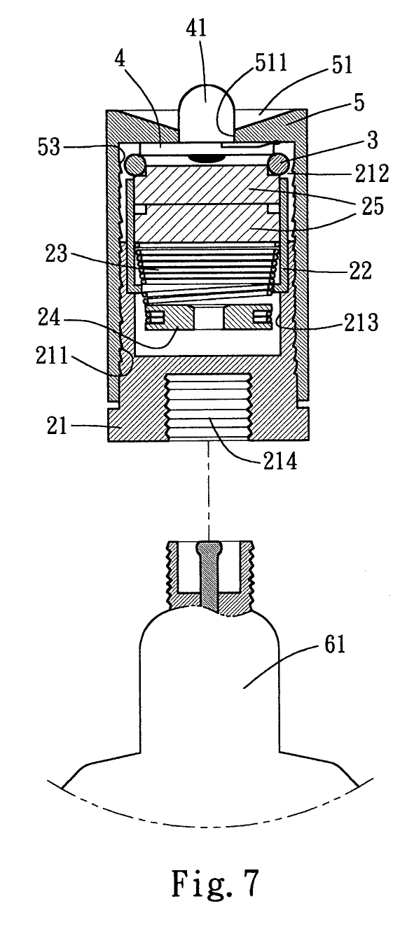

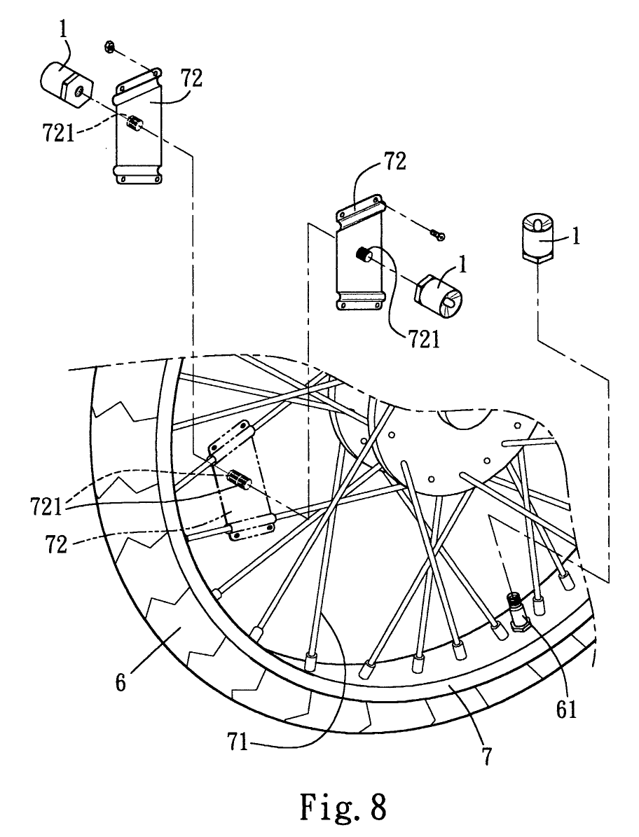

Referring to FIGS. 6-8 and FIGS. 3˜5 again, by means of the bottom screw hole 214 of the casing 2, the centrifugal force-activated signal light assembly 1 can be fastened to the air valve 61 of a vehicle wheel 6, or the fixed screw rod 721 of a mounting plate 72, which is then fastened to the spokes 71 at the rim 7 of the vehicle wheel 6. When the wheel 6 stands still, the weight 24 does not contact the inside wall 213 of the cylindrical chamber 212 of the casing 2, and therefore the circuit is at an open status. During rotation of the wheel 6, the metal conical spring 23 is vibrated, thereby causing the metal weight 24 to touch the inside wall 213 of the cylindrical chamber 212 intermittently. At this time, the battery cells 25 are moved to compress the ring cushion 3 and to touch the positive pole lead wire of the LED 41 intermittently, and therefore the circuit is alternatively closed and opened, and the LED 41 is caused to flash.

In the aforesaid embodiment, the casing 2 and the cover 5 are made of metal. Alternatively, the casing 2 and the cover 5 can be molded from plastics and then respectively electroplated with a layer of electrically conducting material.

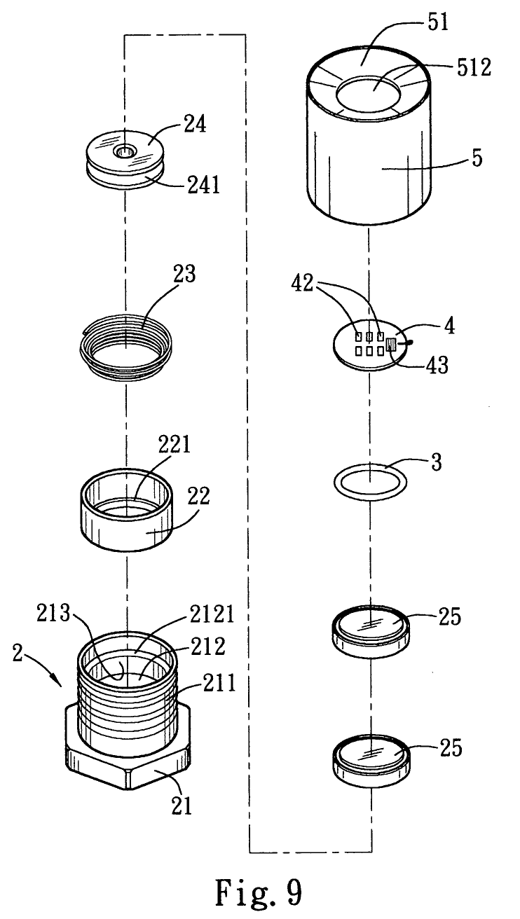

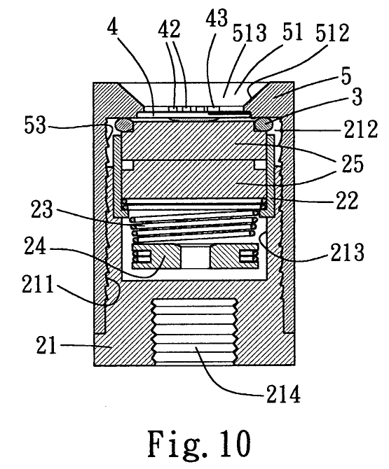

FIGS. 9 and 10 show an alternate form of the centrifugal force-activated signal light assembly. According to this embodiment, light emitting semiconductor chips 42 are used and installed in the circuit board 4 to substitute the aforesaid LED 41, and a photosensitive switch 43 is installed in the circuit board 4 to control connection of the battery cells 25 to the light emitting semiconductor chips 42 subject to the intensity of surrounding light. The light emitting semiconductor chips 42 and the photosensitive switch 43 are exposed to the center hole 512 of the cover 5. Further, transparent glue 513 is adhered to the reflector 51 and covered over the circuit board 4 to protect the light emitting semiconductor chips 42 and the photosensitive switch 43.

A prototype of centrifugal force-activated signal light assembly for vehicles has been constructed with the features of FIGS. 1˜10. The centrifugal force-activated signal light assembly for vehicles functions smoothly to provide all of the features discussed earlier.

Although particular embodiments of the invention have been described in detail for purposes of illustration, various modifications and enhancements may be made without departing from the spirit and scope of the invention. For example, the fans used can be cooling fans for use in hot weather, or fans with electric heater means for use in cold weather. Accordingly, the invention is not to be limited except as by the appended claims.

1. A centrifugal force-activated signal light assembly comprising
an electrically conductive casing, said casing comprising a base, a cylindrical chamber perpendicularly upwardly extended from said base, an outer thread extended around the periphery of said cylindrical chamber, a locating groove inside said cylindrical chamber, and a bottom screw hole at the center of a bottom side of said base for fastening to a vehicle wheel;
an electrically insulative battery holder shaped like a stub tube mounted in the locating groove inside said cylindrical chamber of said casing, said battery holder having an annular inside flange suspended in a bottom open side thereof;
an electrically conducting conical spring suspended from said battery holder inside said cylindrical chamber, said conical spring having a top side of relatively greater diameter fastened to the annular inside flange of said battery holder and a bottom side of relatively smaller diameter spaced below said battery holder at a distance;
an electrically conducting weight fastened to the bottom side of said conical spring and suspended in said cylindrical chamber below said battery holder;
a set of battery cells mounted in said cylindrical chamber and supported on said conical spring, and connected in series with one terminal thereof disposed in contact with said conical spring;
an electrically conducting cover covered on said casing, said cover having an inner thread threaded onto the outer thread of said casing and a reflector provided at a top side thereof and curved inwards, said reflector having a center hole; and
a circuit board mounted inside said cover, said circuit board comprising a light emitting member extended out of the center hole of said reflector, said light emitting member having a first pole connected to said cover and a second pole adapted to contact one terminal of said battery cells for enabling electricity to be transmitted from said battery cells to said light emitting member upon movement of said casing with the vehicle wheel in which said casing is installed.

2. The centrifugal force-activated signal light assembly as claimed in claim 1, further comprising ring cushion mounted in between said battery cells and said circuit board to space the second pole of said light emitting member from the corresponding terminal of said battery cells at a distance.

3. The centrifugal force-activated signal light assembly as claimed in claim 1, wherein said casing and said cover are respectively molded from plastics and electroplated with a layer of electrically conducting material.

4. A centrifugal force-activated signal light assembly comprising:
an electrically conductive casing, said casing comprising a base, a cylindrical chamber perpendicularly upwardly extended from said base, an outer thread extended around the periphery of said cylindrical chamber, a locating groove inside said cylindrical chamber, and a bottom screw hole at the center of a bottom side of said base for fastening to a vehicle wheel;
an electrically insulative battery holder shaped like a stub tube mounted in the locating groove inside said cylindrical chamber of said casing, said battery holder having an annular inside flange suspended in a bottom open side thereof,
an electrically conducting conical spring suspended from said battery holder inside said cylindrical chamber, said conical spring having a top side of relatively greater diameter fastened to the annular inside flange of said battery holder and a bottom side of relatively smaller diameter spaced below said battery holder at a distance;
an electrically conducting weight fastened to the bottom side of said conical spring and suspended in said cylindrical chamber below said battery holder;
a set of battery cells mounted in said cylindrical chamber and supported on said conical spring, and connected in series with one terminal thereof disposed in contact with said conical spring;
an electrically conducting cover covered on said casing, said cover having an inner thread threaded onto the outer thread of said casing and a reflector provided at a top side thereof and curved inwards, said reflector having a center hole; and
a circuit board mounted in said cover, said circuit board comprising a plurality of light emitting semiconductor chips extended out of the center hole of said reflector, said light emitting chips each having a first pole connected to said cover and a second pole disposed in contact with one terminal of said battery cells for enabling electricity to be transmitted from said battery cells to said light emitting semiconductor chips upon movement of said casing with the vehicle wheel in which said casing is installed, and photosensitive switch means adapted to detect the intensity of surrounding light and to control the operation of said light emitting semiconductor chips subject to the intensity of surrounding light upon movement of said casing with the vehicle wheel in which said casing is installed.

5. The centrifugal force-activated signal light assembly as claimed in claim 4, wherein said casing and said cover are respectively molded from plastics and electroplated with a layer of electrically conducting material.

6. The centrifugal force-activated signal light assembly as claimed in claim 4, further comprising a transparent glue covered on said reflector of said cover over said light emitting semiconductor chips and said photosensitive switch means.
